(19) United States
(12) Patent Application Publication
(10) Pub. No.: US 2010/0073311 A1
(43) Pub. Date: Mar. 25, 2010

(54) INPUT HABIT DETERMINATION AND INTERFACE PROVISION SYSTEMS AND METHODS

(76) Inventor: Meng-Chieh YEH, Taoyuan County (TW)

Correspondence Address: BIRCH STEWART KOLASCH & BIRCH, PO BOX 747, FALLS CHURCH, VA, 22040-0747, US

(21) Appl. No.: 12/429,653

(22) Filed: Apr. 24, 2009

(30) Foreign Application Priority Data
Sep. 24, 2008 (TW) 97136631

(51) Int. Cl. G06F 3/041

(52) U.S. Cl. 345/173

(57) ABSTRACT

Input habit determination and interface provision systems and methods are provided. First, a movement on a touch-sensitive surface is detected by a touch-sensitive sensor. An input habit is determined according to the movement. Then, a first interface or a second interface is selected for provision from an interface group according to the input habit. The first interface and the second interface have the same operational selections, but have different layout designs.

### CROSS REFERENCE TO RELATED APPLICATIONS

This Application claims priority of Taiwan Patent Application No. 097136631, filed on Sep. 24, 2008, the entirety of which is incorporated by reference herein.

### BACKGROUND OF THE INVENTION

1. Field of the Invention

The disclosure relates generally to input habit determination and interface provision systems and methods, and, more particularly to systems and methods that automatically determine an input habit and/or provide a corresponding interface according to a movement on a touch-sensitive surface.

2. Description of the Related Art

Recently, electronic devices, such as handheld devices, have become more and more technically advanced and multifunctional. For example, a handheld device may have e-mail message capabilities, an advanced address book management system, a media playback system, and various other functions. Due to increased convenience and functions of the devices, these devices have become necessities of life.

Generally, a set of fixed interfaces are provided to users for related operations. That is, the electronic devices do not consider users' input habits. The electronic devices assume respective users have the same input habits. However, respective users may have different input habits. For example, some users may be right handed, thus they may use their right hands to operate interfaces. Some users may be left handed, thus they may use their left hands to operate interfaces. Therefore, it is inconvenient for users having different input habits when only a set of fixed interfaces is provided for operation.

### BRIEF SUMMARY OF THE INVENTION

Input habit determination and interface provision systems and methods are provided.

An embodiment of an input habit determination system includes a touch-sensitive sensor and a processing unit. The touch-sensitive sensor has a touch-sensitive surface, and detects a movement on the touch-sensitive surface. The processing unit determines an input habit according to the movement.

In an embodiment of an input habit determination method, a movement on a touch-sensitive surface is detected by a touch-sensitive sensor. Then, an input habit is determined according to the movement.

An embodiment of an input habit determination system includes a touch-sensitive sensor, a storage unit, and a processing unit. The touch-sensitive sensor has a touch-sensitive surface, and detects a movement on the touch-sensitive surface. The storage unit includes at least one interface group having a first interface and a second interface. The processing unit determines an input habit according to the movement, and selects the first interface or the second interface for provision according to the input habit.

In an embodiment of an input habit determination method, at least one interface group having a first interface and a second interface is provided. Then, a movement on a touch-sensitive surface is detected by a touch-sensitive sensor. Thereafter, an input habit is determined according to the movement, and the first interface or the second interface is selected for provision according to the input habit.

Input habit determination and interface provision systems and methods, and related operating systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an input habit determination system of the invention;

FIG. 2 is a flowchart of an embodiment of an input habit determination method of the invention;

FIGS. 3A˜3C are schematic diagram illustrating embodiments of movements determined for a right handed input of the invention;

FIGS. 4A˜4C are schematic diagram illustrating embodiments of movements determined for a left handed input of the invention;

FIG. 5 is a schematic diagram illustrating an embodiment of an interface provision system of the invention;

FIGS. 6A and 6B are schematic diagram illustrating embodiments of interfaces corresponding to a right handed input of the invention;

FIGS. 7A and 7B are schematic diagram illustrating embodiments of interfaces corresponding to a left handed input of the invention;

FIG. 8 is a schematic diagram illustrating an embodiment of an interface having sub-zones with different functions; and

FIG. 9 is a flowchart of an embodiment of an interface provision method of the invention.

### DETAILED DESCRIPTION OF THE INVENTION

Input habit determination and interface provision systems and methods are provided.

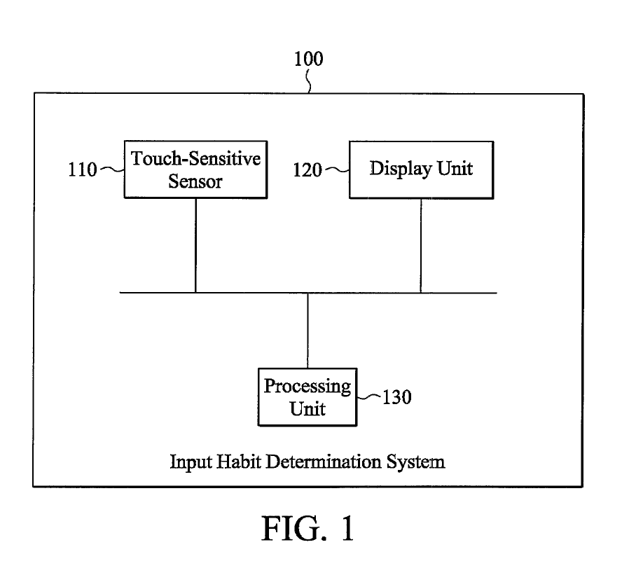

FIG. 1 is a schematic diagram illustrating an embodiment of an input habit determination system of the invention.

The input habit determination system 100 can be used in an electronic device, such as a computer system and a portable device comprising handheld devices such as a media player, a PDA (Personal Digital Assistant), a GPS (Global Positioning System) device, a touch-sensitive phone, a smartphone, and a mobile phone. The input habit determination system 100 comprises a touch-sensitive sensor 110, a display unit 120, and a processing unit 130. The touch-sensitive sensor 110 has a touch-sensitive surface. The touch-sensitive sensor 110 can detect contact and movement of a control tool, such as a stylus or finger on the touch-sensitive surface. The display unit 120 can display related interfaces and data. It is understood that, in some embodiments, the touch-sensitive sensor 110 and the display unit 120 can be integrated as a touch-sensitive display unit. Users can directly review and input data via the touch-sensitive display unit. The processing unit 130 performs input habit determination methods of the invention according to the signals detected by the touch-sensitive sensor 110. Related details are discussed later.

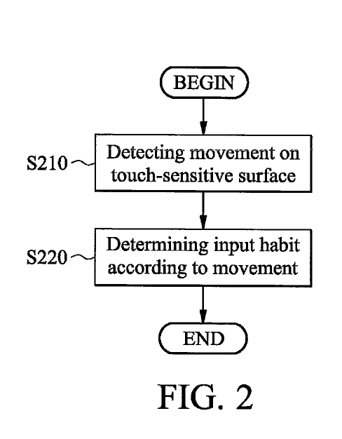

FIG. 2 is a flowchart of an embodiment of an input habit determination method of the invention. The input habit determination method can be used in an electronic device, such as a computer system and a portable device comprising handheld devices such as a media player, a PDA (Personal Digital Assistant), a GPS (Global Positioning System) device, a touch-sensitive phone, a smart phone, and a mobile phone. In step S210, a movement on the touch-sensitive surface is detected by the touch-sensitive sensor of the electronic device. Then, in step S220, an input habit is determined according to the detected movement.

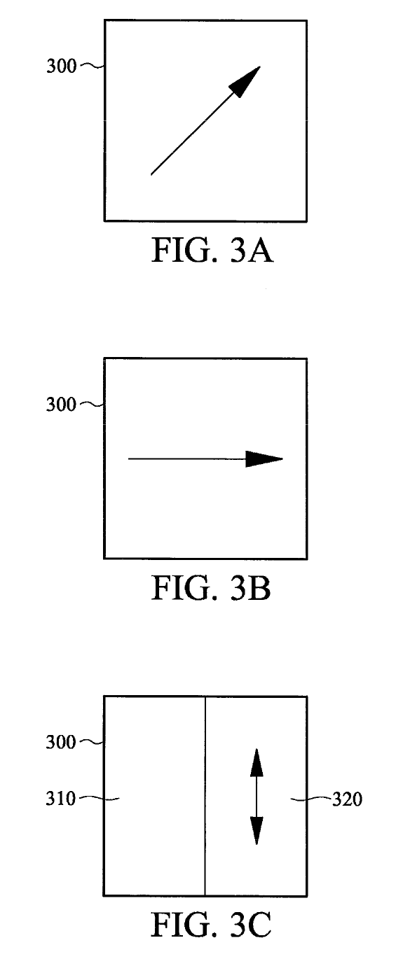

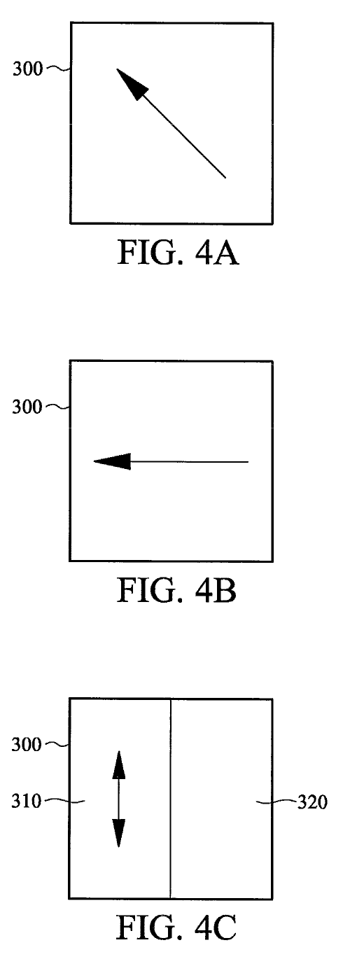

It is understood that, in some embodiments, input habits can be classified into a right handed input and a left handed input. FIGS. 3A˜3C are schematic diagram illustrating embodiments of movements determined for a right handed input of the invention. In some embodiments, when the movement is from the left and bottom of the touch-sensitive surface 300 and slides to the right and top of the touch-sensitive surface 300, as shown in FIG. 3A, the input habit is determined as a right handed input. In some embodiments, when the movement is from the left of the touch-sensitive surface 300 and slides to the right of the touch-sensitive surface 300, as shown in FIG. 3B, the input habit is determined as a right handed input. In some embodiments, the touch-sensitive surface 300 has a left zone 310 and a right zone 320, as shown in FIG. 3C. When the movement slides within the right zone 320 of the touch-sensitive surface 300, the input habit is determined as a right handed input. Additionally, FIGS. 4A˜4C are schematic diagram illustrating embodiments of movements determined for a left handed input of the invention. In some embodiments, when the movement is from the right and bottom of the touch-sensitive surface 300 and slides to the left and top of the touch-sensitive surface 300, as shown in FIG. 4A, the input habit is determined as a left handed input. In some embodiments, when the movement is from the right of the touch-sensitive surface 300 and slides to the left of the touch-sensitive surface 300, as shown in FIG. 4B, the input habit is determined as a left handed input. In some embodiments, when the movement slides within the left zone 310 of the touch-sensitive surface 300, the input habit is determined as a left handed input. It is noted that, the above embodiments are examples of the invention, and the invention is not limited thereto.

It is understood that, in some embodiments, the electronic device may stay in a locked state. When a movement is detected by the touch-sensitive sensor 110, the electronic device can be unlocked according to the movement. Additionally, in some embodiments, the input habit determination can be performed under some predefined interfaces. That is, when the display unit 120 of the electronic device displays a specific interface, the processing unit 130 can determine whether the specific interface is a predefined interface. If the specific interface is the predefined interface, the processing unit 130 performs input habit determination.

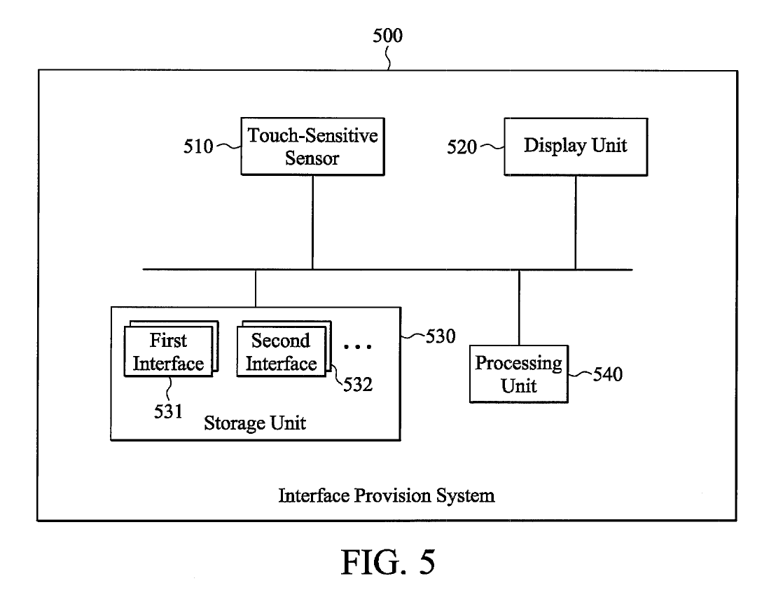

FIG. 5 is a schematic diagram illustrating an embodiment of an interface provision system of the invention.

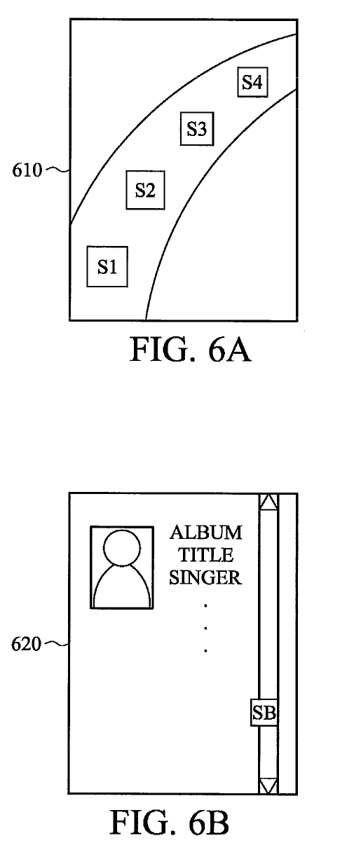

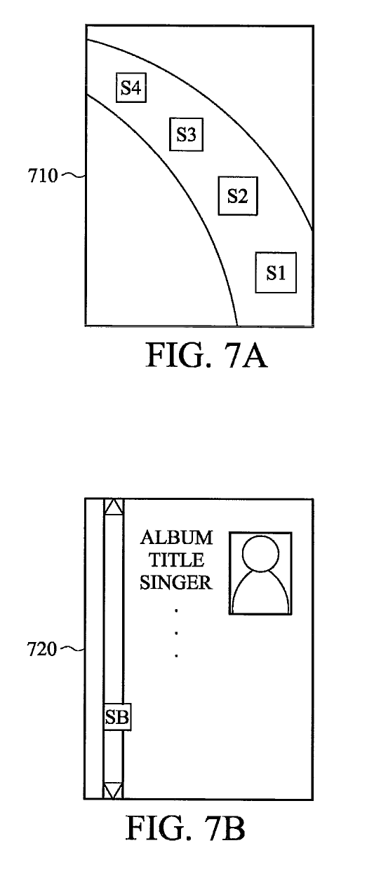

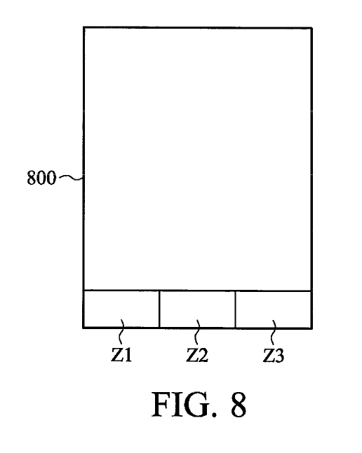

The interface provision system 500 can be used in an electronic device, such as a computer system and a portable device comprising handheld devices such as a media player, a PDA (Personal Digital Assistant), a GPS (Global Positioning System) device, a touch-sensitive phone, a smartphone, and a mobile phone. The interface provision system 500 comprises a touch-sensitive sensor 510, a display unit 520, a storage unit 530, and a processing unit 540. The touch-sensitive sensor 510 has a touch-sensitive surface. The touch-sensitive sensor 510 can detect contact and movement of a control tool, such as a stylus or finger on the touch-sensitive surface. The display unit 520 can display related interfaces and data. It is understood that, in some embodiments, the touch-sensitive sensor 510 and the display unit 520 can be integrated as a touch-sensitive display unit. Users can directly review and input data via the touch-sensitive display unit. The storage unit 530 comprises at least one interface group. Each interface group may correspond to a function. Each interface group comprises a first interface 531 and a second interface 532. The first interface 531 and the second interface 532 have the same operational selections corresponding to the functions, but have different layout designs. In some embodiments, the first interface 531 can be designed for users having a right-handed input habit. The layout design of the first interface 531 may have a prompt corresponding to the right handed input. For example, FIGS. 6A and 6B are schematic diagram illustrating embodiments of interfaces corresponding to a right handed input of the invention. The first interface 610 has several operational selections (S1, S2, S3 and S4) corresponding to a function. Since the first interface 610 is designed for users having the right-handed input habit, the movement corresponding to the right handed input can be from the left and bottom and slides to the right and top of the touch-sensitive surface, or from the left and slides to the right of the touch-sensitive surface. Therefore, in the layout design of the first interface 610, the operational selections (S1, S2, S3 and S4) can be arranged according to the direction of the movement to prompt users, as shown in FIG. 6A. Similarly, in FIG. 6B, the layout design of the first interface 620 may have a scroll bar and a control mark SB of the scroll bar at the right side of the interface to prompt users. Additionally, the second interface 532 can be designed for users having a left-handed input habit. The layout design of the second interface 532 may have a prompt corresponding to the left handed input. For example, FIGS. 7A and 7B are schematic diagram illustrating embodiments of interfaces corresponding to a left handed input of the invention. It is noted that the second interface 710 has the same operational selections (S1, S2, S3 and S4) as that in the first interface 610. Since the second interface 710 is designed for users having the left-handed input habit, the movement corresponding to the left handed input can be from the right and bottom and slides to the left and top of the touch-sensitive surface, or from the right and slides to the left of the touch-sensitive surface. Therefore, in the layout design of the second interface 710, the operational selections (S1, S2, S3 and S4) can be arranged according to the direction of the movement to prompt users, as shown in FIG. 7A. Similarly, in FIG. 7B, the layout design of the second interface 720 may have a scroll bar and a control mark SB of the scroll bar at the left side of the interface to prompt users. As described, the electronic device may provide several functions, and each function may correspond to an interface group. Therefore, in some embodiments, the interface group can be determined according to the function to be activated. FIG. 8 is a schematic diagram illustrating an embodiment of an interface having sub-zones with different functions. In this example, the interface 800 has sub-zones Z1, Z2, and Z3. Each sub-zone can correspond to a function. When the beginning position of a movement is within a specific sub-zone, the interface group corresponding to the specific sub-zone is retrieved. The processing unit 540 performs interface provision methods of the invention according to the signals detected by the touch-sensitive sensor 510. Related details are discussed later.

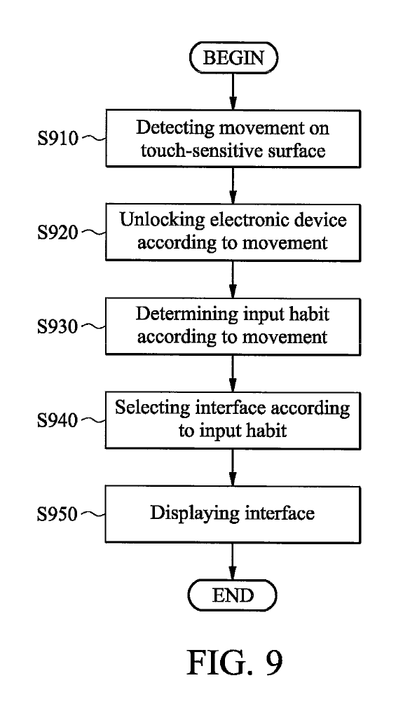

FIG. 9 is a flowchart of an embodiment of an interface provision method of the invention. The interface provision method can be used in an electronic device, such as a computer system and a portable device comprising handheld devices such as a media player, a PDA (Personal Digital Assistant), a GPS (Global Positioning System) device, a touch-sensitive phone, a smart phone, and a mobile phone.

In step S910, a movement on the touch-sensitive surface is detected by the touch-sensitive sensor of the electronic device. Then, in step S920, the electronic device is unlocked according to the movement. It is understood that, in some embodiments, when the electronic device is not at a locked state, step S920 can be omitted. Then, in step S930, an input habit is determined according to the detected movement. Similarly, in some embodiments, input habits can be classified into a right handed input and a left handed input. When the movement is from the left and bottom of the touch-sensitive surface 300 and slides to the right and top of the touch-sensitive surface 300, the movement is from the left of the touch-sensitive surface 300 and slides to the right of the touch-sensitive surface 300, or the movement slides within the right zone 320 of the touch-sensitive surface 300, the input habit is determined as a right handed input. Additionally, when the movement is from the right and bottom of the touch-sensitive surface 300 and slides to the left and top of the touch-sensitive surface 300, the movement is from the right of the touch-sensitive surface 300 and slides to the left of the touch-sensitive surface 300, or the movement slides within the left zone 310 of the touch-sensitive surface 300, the input habit is determined as a left handed input. In step S940, the first interface or the second interface in the interface group is selected according to the input habit, and in step S950, the selected interface is displayed.

It is understood that, as described, different functions may correspond to different interface groups. In some embodiments, an interface group can be first determined according to an activated function, and a specific interface is selected from the determined interface group according to the input habit. Similarly, in some embodiments, the input habit determination can be performed under some predefined interfaces. When the display unit 520 of the electronic device displays a specific interface, the processing unit 540 can determine whether the specific interface is a predefined interface. If the specific interface is the predefined interface, the processing unit 540 performs input habit determination.

Therefore, the input habit determination and interface provision systems and methods can automatically determine the input habit and/or provide corresponding interfaces according to the movement on the touch-sensitive surface.

Input habit determination and interface provision systems and methods, and related operating systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An input habit determination system for use in an electronic device, comprising:
a touch-sensitive sensor having a touch-sensitive surface, detecting a movement on the touch-sensitive surface; and
a processing unit determining an input habit according to the movement.

2. The system of claim 1, wherein when the movement is from the left and bottom of the touch-sensitive surface and slides to the right and top of the touch-sensitive surface, the movement is from the left of the touch-sensitive surface and slides to the right of the touch-sensitive surface, or the movement slides within a right zone of the touch-sensitive surface, the processing unit determines the input habit is a right handed input.

3. The system of claim 1, wherein when the movement is from the right and bottom of the touch-sensitive surface and slides to the left and top of the touch-sensitive surface, the movement is from the right of the touch-sensitive surface and slides to the left of the touch-sensitive surface, or the movement slides within a left zone of the touch-sensitive surface, the processing unit determines the input habit is a left handed input.

4. The system of claim 1, further comprising a display unit displaying a specific interface, wherein the processing unit further determines whether the specific interface is a predefined interface, and when the specific interface is the predefined interface, the processing unit performs the determination of the input habit.

5. An interface provision system for use in an electronic device, comprising:
a touch-sensitive sensor having a touch-sensitive surface, and detecting a movement on the touch-sensitive surface;
a storage unit comprising at least one interface group having a first interface and a second interface; and
a processing unit determining an input habit according to the movement, and selecting the first interface or the second interface for provision according to the input habit.

6. The system of claim 5, wherein when the movement is from the left and bottom of the touch-sensitive surface and slides to the right and top of the touch-sensitive surface, the movement is from the left of the touch-sensitive surface and slides to the right of the touch-sensitive surface, or the movement slides within a right zone of the touch-sensitive surface, the processing unit determines the input habit is a right handed input, and selects the first interface for provision, wherein a layout design of the first interface has a prompt corresponding to the right handed input.

7. The system of claim 5, wherein when the movement is from the right and bottom of the touch-sensitive surface and slides to the left and top of the touch-sensitive surface, the movement is from the right of the touch-sensitive surface and slides to the left of the touch-sensitive surface, or the movement slides within a left zone of the touch-sensitive surface, the processing unit determines the input habit is a left handed input, and selects the second interface for provision, wherein a layout design of the second interface has a prompt corresponding to the left handed input.

8. The system of claim 5, further comprising a display unit displaying a specific interface, wherein the processing unit further determines whether the specific interface is a predefined interface, and when the specific interface is the predefined interface, the processing unit performs the determination of the input habit.

9. The system of claim 5, wherein the at least one interface group respectively corresponds to a function, and the processing unit further determines a specific function according to a beginning position of the movement, and selects the first interface or the second interface for provision from the interface group corresponding to the specific function according to the input habit.

10. The system of claim 5, wherein the first interface and the second interface have the same operational selections, but have different layout designs.

11. An input habit determination method for use in an electronic device, comprising:
detecting a movement on a touch-sensitive surface by a touch-sensitive sensor; and
determining an input habit according to the movement.

12. The method of claim 11, wherein when the movement is from the left and bottom of the touch-sensitive surface and slides to the right and top of the touch-sensitive surface, the movement is from the left of the touch-sensitive surface and slides to the right of the touch-sensitive surface, or the movement slides within a right zone of the touch-sensitive surface, the input habit is determined as a right handed input.

13. The method of claim 11, wherein when the movement is from the right and bottom of the touch-sensitive surface and slides to the left and top of the touch-sensitive surface, the movement is from the right of the touch-sensitive surface and slides to the left of the touch-sensitive surface, or the movement slides within a left zone of the touch-sensitive surface, the input habit is determined as a left handed input.

14. The method of claim 11, further comprising:
determining whether a specific interface displayed in a display unit is a predefined interface; and
when the specific interface is the predefined interface, performing the determination of the input habit.

15. An interface provision method for use in an electronic device, comprising:
providing at least one interface group having a first interface and a second interface;
detecting a movement on a touch-sensitive surface by a touch-sensitive sensor;
determining an input habit according to the movement; and
selecting the first interface or the second interface for provision according to the input habit.

16. The method of claim 15, wherein when the movement is from the left and bottom of the touch-sensitive surface and slides to the right and top of the touch-sensitive surface, the movement is from the left of the touch-sensitive surface and slides to the right of the touch-sensitive surface, or the movement slides within a right zone of the touch-sensitive surface, the input habit is determined as a right handed input, and the first interface is selected for provision, wherein a layout design of the first interface has a prompt corresponding to the right handed input.

17. The method of claim 15, wherein when the movement is from the right and bottom of the touch-sensitive surface and slides to the left and top of the touch-sensitive surface, the movement is from the right of the touch-sensitive surface and slides to the left of the touch-sensitive surface, or the movement slides within a left zone of the touch-sensitive surface, the input habit is determined as a left handed input, and the second interface is selected for provision, wherein a layout design of the second interface has a prompt corresponding to the left handed input.

18. The method of claim 15, further comprising:
determining whether a specific interface displayed by a display unit is a predefined interface; and
when the specific interface is the predefined interface, performing the determination of the input habit.

19. The method of claim 15, wherein the at least one interface group respectively corresponds to a function, and the method further comprises the steps of:
determining a specific function according to a beginning position of the movement; and
selecting the first interface or the second interface for provision from the interface group corresponding to the specific function according to the input habit.

20. The method of claim 15, wherein the first interface and the second interface have the same operational selections, but have different layout designs.
